(19) United States
(12) Patent Application Publication
(10) Pub. No.: US 2006/0048399 A1
(43) Pub. Date: Mar. 9, 2006

(54) Laser line projection device

(76) Inventor: Shih-Chang Chang, Sinhua Township (TW)

Correspondence Address: Raymond Sun, 12420 Woodhall Way, Tustin, CA, 92782, US

(21) Appl. No.: 11/021,158

(22) Filed: Dec. 23, 2004

(30) Foreign Application Priority Data
Sep. 3, 2004 (TW) 93126601

(51) Int. Cl. G01C 15/00

(52) U.S. Cl. 33/286

(57) ABSTRACT

A laser line projection device has a plumb, a first mechanism connected with the plumb to enable the plumb to oscillate, in accordance with gravity, about a first axis with respect to the base, and a second mechanism connected with the base and the first mechanism to enable the plumb to oscillate, in accordance with gravity, about a second axis with respect to the base. A laser beam generator is arranged on the plumb to project a laser beam for producing a laser line on a target.

### BACKGROUND OF THE INVENTION

1. Field of the Invention

The present invention relates to a laser line projection device, and in particular, to a laser line projection device that provides a dual-axis positioning function.

2. Description of the Prior Art

The demarcation of reference lines is one of the most important factors affecting precision in architectural, construction and decoration applications. Recently, a laser line projection device capable of projecting a laser beam for producing a plumb laser line or a horizontal laser line on a target has become very important.

The conventional laser line projection device typically uses a plumb to automatically level the laser line. To minimize cost, the conventional laser line projection device does not use multiple bearings to provide multi-axis rotation, but instead employs a single bearing for providing single-axis rotation to produce a plumb laser line. Although the conventional laser line projection device can use the single bearing to correct the verticality of the plumb laser line, the entire conventional laser line projection device may sometimes become tilted by a large angle in the axis direction of rotation. This tilting will negatively impact the precision of the plumb laser line because the single bearing will be operating in a tilted position.

Thus, there still remains a need for a laser line projection device which can automatically level itself to improve the precision of the laser line, and improve the ease of use for the user.

### SUMMARY OF THE DISCLOSURE

It is an object of the present invention to provide a laser line projection device which employs dual-axis adjustment to enhance the precision of the projected laser line.

It is another object of the present invention to provide a laser line projection device having a bearing and a loose fit mechanism to achieve dual-axis positioning, thereby cutting cost.

In order to accomplish the objects of the present invention, the present invention provides a laser line projection device that has a plumb, a pivoting mechanism connected with the plumb to enable the plumb to oscillate (upon the influence of gravity) about a first axis with respect to the base, and a loose-fit mechanism connected with the base and the pivoting mechanism to enable the plumb to oscillate (upon the influence of gravity) about a second axis with respect to the base. A laser beam generator is arranged on the plumb to project a laser beam for producing a laser line on a target.

According to one embodiment of the present invention, the pivoting mechanism is a bearing, and the loose fit mechanism includes a holder and a pin. The holder has at least a through-hole and a connection opening which receives the bearing, and the pin extends through the at least one through-hole and is coupled to the base.

### BRIEF DESCRIPTION OF THE DRAWINGS

FIG. 1 is a perspective view of a laser line projection device in accordance with one embodiment of the present invention.

FIG. 2 is an exploded perspective view of the laser line projection device of FIG. 1.

FIG. 3 is a top plan view of the base of the laser line projection device of FIG. 1.

FIG. 4 is an exploded perspective view of the laser line projection device of FIG. 1 shown with a modified loose fit mechanism.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

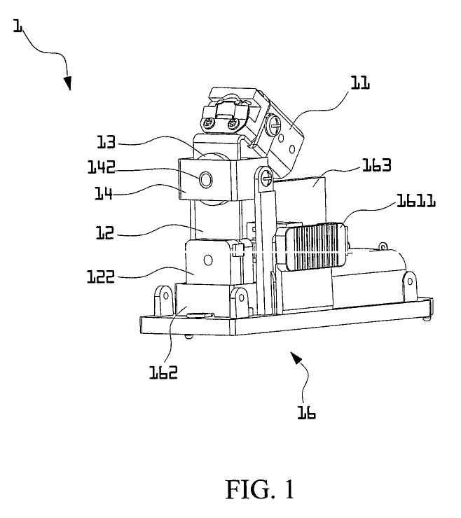

Referring to FIGS. 1-3, the laser line projection device 1 according to one embodiment of the present invention includes a base 16, a laser beam generator 11, a plumb 12, a bearing 13, and a loose fit mechanism having a holder 14 and a pin 15.

To increase the precision of the projection laser line and to reduce costs, the plumb 12 is not connected to the base 16 by a single bearing or multiple bearings. The plumb 12 is connected to the base 16 by the bearing 13, the holder 14 and the pin 15.

The plumb 12 has an opening 121 provided in a vertical support 123, and a pure-copper bar 122 provided at the bottom end of the vertical support 123. A curved bracket 124 is provided at the top end of the vertical support 123. Two opposing support bars 125 extend upwardly from the bracket 124, with each support bar 125 having an opening 126, with the openings 126 aligned with each other. The laser beam generator 11 is secured to the support bars 125 of the plumb 12 via screws 111 and 112 that extend through corresponding openings 126. The laser beam generator 11 projects a laser beam for producing a laser line on a target (not shown).

The bearing 13 is adapted to be fitted in the opening 121 in the plumb 12, and has a bearing hole 131 that is adapted to receive a portion of a shaft 17. The shaft 17 functions to connect the bearing 13 (and the plumb 12 carried thereon) to the holder 14, as described below.

The holder 14 has a U-shaped body having a pair of aligned through-holes 141 and a connection opening 142 that is oriented perpendicular to the through-holes 141. A portion of the shaft 17 extends into the connection opening 142 to connect the holder 14 to the plumb 12.

The holder 14 is connected to the base 16 via the pin 15. The pin 15 is inserted through the aligned through-holes 141 in the holder 14 and then secured to the base 16 via a pair of screws 1601 and 1602. In particular, the base 16 has an opposing pair of vertical legs 168, with each vertical leg 168 having an opening 1681 that is aligned with the other opening 1681. Each opening 1681 is also aligned with a corresponding through-hole 141. Each screw 1601 and 1602 extends through a corresponding opening 1681 and a corresponding through-hole 141 to be connected to an opposing end of the pin 15. Each opposing end of the pin 15 has a bore or opening which is adapted to receive a corresponding screw 1601 or 1602. The holder 14 is pivoting supported on the pin 15 to allow the holder 14 and its plumb 12 to be pivotally suspended from the pin 15.

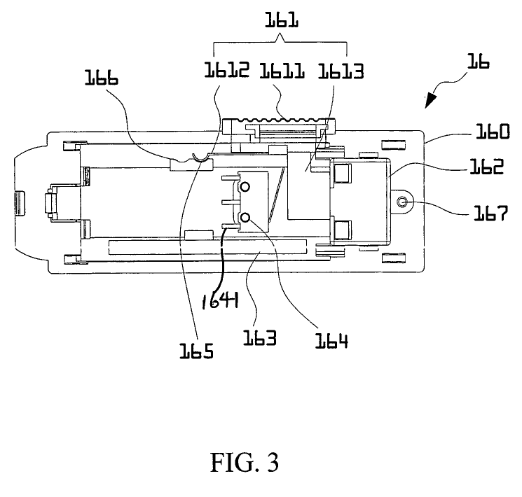

Referring also to FIG. 3, the base 16 has a micro-switch 164, a slide switch 161, an electronic controller board 163, and a case 160 with a magnet 162. A battery or battery set (not shown, hereinafter referred to collectively as “battery”) is retained in the base 16 to power the laser line projection device 1, and the battery is electrically coupled to the electronic controller board 163 (as described below). The case 160 has a connection point 167, a first notch 165 and a second notch 166.

One of the positive or negative electrodes of the battery is connected to a pin (e.g., 1641) of the micro-switch 164, which is connected to the controller board 163 via another pin (not shown) of the micro-switch 164. The other electrode of the battery is also connected to the controller board 163 such that the transmission of electricity (i.e., power) from the battery can be controlled by the micro-switch 164 by operating the slide switch 161. In addition, two wires (not shown) directly connect the controller board 163 and the laser beam generator 11 to supply power from the battery (in the base 16) to the light source in the laser beam generator 11. In this regard, the laser beam generator 11 can be provided with a metal housing that is connected to the positive electricity.

The slide switch 161 cooperates with the first notch 165 and the second notch 166 during its operation. The slide switch 161 is provided on one side of the case 160 of the base 16 and has a sliding part 1611, an actuation part 1613, and a spring plate 1612. During operation, the sliding part 1611 of the slide switch 161 is actuated to drive the actuation part 1613 and the spring plate 1612, both of which are connected with the sliding part 1611, such that the spring plate 1612 is moved to slide into the first notch 165 and the second notch 166, and with the actuation part 1613 switching between a first location and a second location.

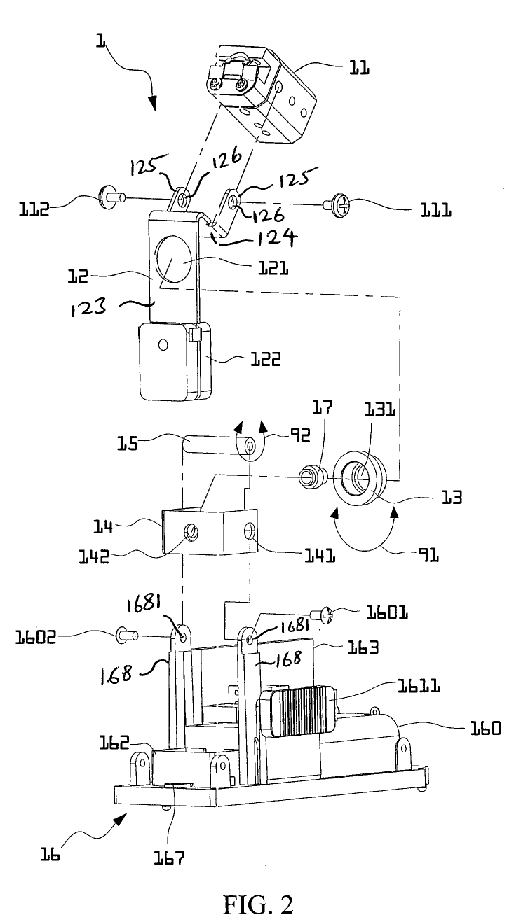

As shown in FIG. 3, when the spring plate 1612 is positioned in the first notch 165, the actuation part 1613 is at the first location, where the actuation part 1613 contacts the plumb 12. When the spring plate 1612 is positioned in the second notch 166, the actuation part 1613 is at the second location (not shown), where the actuation part 1613 triggers the micro-switch 164. In other words, when the spring plate 1612 is positioned in the first notch 165, the electricity transmitted from the micro-switch 164 to the laser beam generator 11 will be disconnected and the actuation part 1613 is driven to contact and lock the plumb 12 by the friction between them, thereby preventing the plumb 12 from oscillating when the laser line projection device 1 is not in use. Conversely, when the spring plate 1612 is positioned in the second notch 166, the electricity transmitted from the micro-switch 164 to the laser beam generator 11 will be connected, and the actuation part 1613 is driven away from the plumb 12 to unlock the plumb 12, thereby enabling the plumb 12 to oscillate depending on the force of gravity. The oscillation of the plumb 12 can be along two axes with respect to the base 16: a first axis direction 91 (about the bearing 13) and a second axis direction 92 (about the pin 15), where the first axis direction 91 is perpendicular to the second axis direction 92. See FIG. 2.

The magnet 162 is attached on a vertical wall of the case 160. This vertical wall is shaped like an enclosure, and the plumb 12 is suspended so that its copper bar 122 is retained in the space defined by this enclosure. Since the magnet 162 is positioned on the base 16 at a location that corresponds to the location of the copper bar 122, the plumb 12 can quickly stop its oscillating motion when the base 16 is tilted, because the copper bar 122 functions to cut off the magnetic lines of the magnet 162.

The connection point 167 is electrically connected with the electronic controller board 163 to detect the tilting angle of the case 160 so that the electronic controller board 163 will send a warning signal to the user when the tilting angle of the case 160 exceeds a preset value. This occurs when the plumb 12 is tilted to the point where the copper bar 122 contacts the magnet 162, thereby forming a closed electrical circuit where the positive electricity of the metal housing (of the laser beam generator 11) is transmitted back to the controller board 163 via a path that includes the plumb 12, the case 160, the connection point 167, and a wire (not shown) between the connection point 167 and the controller board 163 when the plumb 12 contacts the base 16 due to tilting of the laser line projection device 1. To facilitate this, all the elements of the transmission path are preferably made of conductive materials.

Thus, the laser line projection device 1 employs a pivoting mechanism (the bearing 13) and a loose fit mechanism (the holder 14 and the pin 15) to allow for adjustment of the laser beam generator 11 along two axes. Only one bearing 13 is needed to accomplish the dual-axis adjustment.

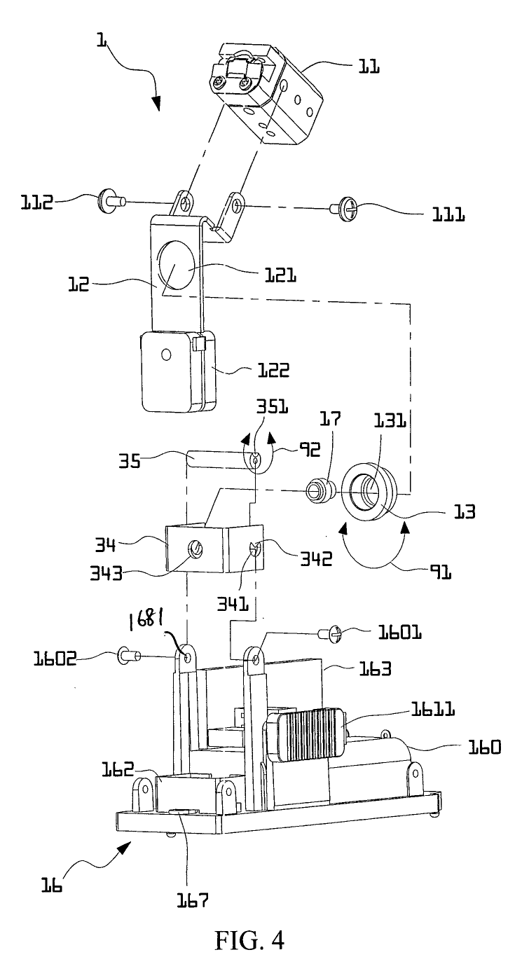

FIG. 4 illustrates a modification that can be made to the laser line projection device 1. The laser line projection device 1 shown in FIG. 4 is identical to the laser line projection device 1 shown in FIG. 1 and operates in the same manner, except that the loose fit mechanism (holder 34 and pin 35) is modified. Therefore, other than the holder 34 and the pin 35, the other elements in FIG. 4 have the same numeral designations as the same elements in FIGS. 1-3, and no further description of these elements is needed herein.

The holder 34 differs from the holder 14 in that the through-holes 341 have a different configuration than the through-holes 141 in that each through-hole 341 is provided a V-shaped projection 342 that functions as a holding point. In addition, the pin 35 differs from the pin 15 in that the pin 35 has a longitudinal curved notch 351 that is adapted to receive the V-shaped projections 342. The pin 35 is adapted to be inserted through the through-holes 341 of the holder 34, and then through the aligned openings 1681 in the vertical legs 168, to be secured to the base 16 via the screws 1601 and 1602. Finally, the connection opening 343 can have the same configuration as the connection opening 142.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A laser line projection device, comprising:
a base;
a plumb;
a pivoting mechanism connected with the plumb to enable the plumb to oscillate, under the influence of gravity, about a first axis with respect to the base;
a loose fit mechanism connected with the base and the pivoting mechanism to enable the plumb to oscillate, under the influence of gravity, about a second axis with respect to the base; and
a laser beam generator arranged on the plumb to project a laser beam for producing a laser line on a target.

2. The device of claim 1, wherein the pivoting mechanism is a bearing.

3. The device of claim 2, wherein the loose fit mechanism comprises:
a holder having at least a through-hole and a connection opening which receives the bearing; and
a pin extending through the at least one through-hole and coupled to the base.

4. The device of claim 3, wherein the connection opening is perpendicular to the at least one through-hole.

5. The device of claim 3, wherein the at least one through-hole provided with a projection, and the pin has a longitudinal curved notch that receives the projection from the at least one through-hole.

6. The device of claim 1, wherein the base has a magnet, and the plumb has a pure-copper bar positioned corresponding to the position of the magnet.

7. The device of claim 1, wherein the oscillation directions of the first axis and the second axis are perpendicular to each other.

8. The device of claim 1, wherein the base comprises:
a case having a first notch, a second notch, and a connection point;
a micro-switch provided on the case to control the electricity transmitted to the laser beam generator;
a slide switch provided on one side of the case to switch between the locking of the plumb and the triggering of the micro-switch; and
an electronic controller board provided on the case and electrically connected with the connection point to generate a warning signal when the case tilts by an angle that exceeds a preset value.

9. The device of claim 8, wherein the slide switch includes:
a sliding part;
a spring plate connected with the sliding part being received in either the first notch or the second notch; and
an actuation part connected with the sliding part for switching between the locking of the plumb and the triggering of the micro-switch while the spring plate slides between the first notch and the second notch.

10. The device of claim 1, wherein the laser beam generator is secured onto the plumb by screws.

11. The device of claim 1, wherein the loose fit mechanism is pivotally coupled to the pivoting mechanism.

12. A laser line projection device, comprising:
a base;
a plumb;
a bearing connected with the plumb to enable the plumb to oscillate, under the influence of gravity, about a first axis with respect to the base;
a holder having at least a through-hole and a connection opening which receives the bearing for pivoting motion therein;
a pin extending through the at least one through-hole and coupled to the base to enable the plumb to oscillate, under the influence of gravity, about a second axis with respect to the base; and
a laser beam generator arranged on the plumb to project a laser beam for producing a laser line on a target;
wherein the oscillation directions of the first axis and the second axis are perpendicular to each other.

13. The device of claim 12, wherein the connection opening is perpendicular to the at least one through-hole.

14. The device of claim 12, wherein the oscillation directions of the first axis and the second axis are perpendicular to each other.
